(19) United States
(12) Patent Application Publication
(10) Pub. No.: US 2022/0256496 A1
(43) Pub. Date: Aug. 11, 2022

(54) CONSTANT-INFORMATION RANGING FOR DYNAMIC SPECTRUM ACCESS IN A JOINT POSITIONING-COMMUNICATIONS SYSTEM

(71) Applicants: Sharanya Srinivas, Tempe, AZ (US); Daniel W. Bliss, Phoenix, AZ (US)

(72) Inventors: Sharanya Srinivas, Tempe, AZ (US); Daniel W. Bliss, Phoenix, AZ (US)

(73) Assignee: Arizona Board of Regents on behalf of Arizona State University, Scottsdale, AZ (US)

(21) Appl. No.: 17/589,245

(22) Filed: Jan. 31, 2022

Related U.S. Application Data
(60) Provisional application No. 63/143,093, filed on Jan. 29, 2021.

(51) Int. Cl. H04W 64/00; H04W 28/18; G01S 13/76

(52) U.S. Cl. CPC H04W 64/006; G01S 13/765; H04W 28/18

(57) ABSTRACT

Constant information ranging for dynamic spectrum access in a joint positioning-communications system is provided. Embodiments described herein provide a simultaneous positioning, navigation, timing, and communications system that cooperatively executes multiple radio frequency (RF) services. A constant-information ranging (CIR) strategy or algorithm is defined that maintains constant information learned about an incoherent moving target by modulating a revisit interval to minimize the number of interactions. This significantly reduces spectral congestion and offers a control mechanism to dynamically manage spectral access. The CIR algorithm is validated in a simulation environment where a 91% reduction in spectral access for a particular flight path is observed while maintaining a 3-centimeter (cm) precision in ranging.

### RELATED APPLICATIONS

This application claims the benefit of provisional patent application Ser. No. 63/143,093, filed Jan. 29, 2021, the disclosure of which is hereby incorporated herein by reference in its entirety.

### FIELD OF THE DISCLOSURE

The present disclosure relates to relative positioning of vehicles based on an exchange of wireless signals.

### BACKGROUND

Spectral congestion limits the opportunities and performance of radio frequency (RF) systems. Every RF device must share limited spectral resources, which becomes increasingly challenging as more devices are introduced into congested environments. Spectral isolation offered sufficient interference mitigation in the past, but now that every spectrum allocation is filled it does not provide a scalable solution for adding more devices.

Modern RF technologies must be supported by efficient resource management strategies and cooperation techniques to overcome spectral congestion. RF convergence is a growing field of cooperative design techniques that enable significant performance and efficiency enhancements for a broad range of RF systems. Many of these techniques promise significantly lesser resource consumption, but they also require cooperation between different types of RF applications. These techniques offer feasible solutions for many types of RF systems, but they require a significant paradigm shift from traditional system design techniques.

Intelligent transportation systems (ITS) are increasingly popular, promising unprecedented transportation safety and efficiency. These systems, however, require several simultaneous RF services such as radar, communications, and positioning, navigation, and timing (PNT). This significantly increases spectral congestion, especially as more vehicles begin to adopt these systems.

### SUMMARY

Constant information ranging for dynamic spectrum access in a joint positioning-communications system is provided. Spectral congestion limits the opportunities and performance of radio frequency (RF) systems. Spectral isolation sufficiently mitigates this congestion for a small number of users but does not offer a scalable solution once the entire spectrum is occupied. Dynamic resource management supports higher user densities by constantly renegotiating spectral access depending on need and opportunity. This approach promises efficient spectral access but is predicated on cooperation between different types of RF systems, which is a significant paradigm shift for many legacy technologies. Intelligent transportation systems (ITS) rely on several different types of RF services such as radar, communications, and positioning, navigation, and timing (PNT). RF convergence demonstrates that many of these systems can be executed simultaneously using efficient cooperation strategies, which improves performance and limits spectral access.

Embodiments described herein provide a simultaneous positioning, navigation, timing, and communications system that cooperatively executes multiple RF services. A constant-information ranging (CIR) strategy or algorithm is defined that maintains constant information learned about an incoherent moving target by modulating a revisit interval to minimize the number of interactions. This significantly reduces spectral congestion and offers a control mechanism to dynamically manage spectral access. The CIR algorithm is validated in a simulation environment where a 91% reduction in spectral access for a particular flight path is observed while maintaining a 3-centimeter (cm) precision in ranging.

An exemplary embodiment provides a method for information ranging in a joint positioning-communications system, the method comprising: receiving a first signal from a first network node over a joint positioning-communications waveform; predicting position states of the first network node at a plurality of hypothetical revisit times based on the first signal; and adjusting a revisit time of the joint positioning-communications waveform based on the predicted position states and a target performance metric.

Another exemplary embodiment provides a RF device, comprising: an RF transceiver; and a signal processor coupled to the RF transceiver and configured to: receive a first signal from a first network node over a joint positioning-communications waveform, predict position information for the first network node at a plurality of revisit times based on the first signal, and adjust timing of the joint positioning-communications waveform based on the predicted position information and a target performance metric.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1 is a schematic diagram of an exemplary Communications and High-Precision Positioning (CHP2) system which provides joint positioning and communications according to embodiments disclosed herein.

FIG. 2 is a schematic diagram of the CHP2 system of FIG. 1, illustrating estimation of position information based on exchanging radio frequency (RF) signals between a first network node and a second network node.

FIG. 3A is a schematic diagram of the CHP2 system, illustrating a clock offset between the first network node and the second network node of FIG. 2.

FIG. 3B is a schematic diagram of interactions between the first network node and the second network node of the CHP2 system of FIG. 2 over a joint positioning-communications waveform.

FIG. 4 is a schematic diagram of the CHP2 system of FIG. 2 implementing a constant-information ranging (CIR) algorithm.

FIG. 5 is a flow diagram illustrating an exemplary timing exchange model at node A of FIG. 4 summarizing interactions between node A and node B.

FIG. 6 is a flow diagram illustrating an updated timing exchange model as in FIG. 5 for dynamically reducing spectral access when a target behaves predictably.

FIG. 7 is a graphical representation of a simulated flight trajectory of node B for 60 seconds with node A located at the origin.

FIG. 8 is a graphical representation of true and estimated relative time-of-flight (ToF) and radial velocity between node A and node B.

FIG. 9 is a graphical representation of true and estimated relative clock offset and drift between node A and node B.

FIG. 10 is a graphical representation of optimal cycle length to maintain a constant information of 15 bits at each measurement instance.

FIG. 11 is a flow diagram illustrating a process for information ranging in a joint positioning-communications system.

FIG. 12 is a schematic diagram of a generalized representation of an exemplary computer system that could be used to perform any of the methods or functions described above, such as constant-information ranging in a joint positioning-communications system.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Constant information ranging for dynamic spectrum access in a joint positioning-communications system is provided. Spectral congestion limits the opportunities and performance of radio frequency (RF) systems. Spectral isolation sufficiently mitigates this congestion for a small number of users but does not offer a scalable solution once the entire spectrum is occupied. Dynamic resource management supports higher user densities by constantly renegotiating spectral access depending on need and opportunity. This approach promises efficient spectral access but is predicated on cooperation between different types of RF systems, which is a significant paradigm shift for many legacy technologies. Intelligent transportation systems (ITS) rely on several different types of RF services such as radar, communications, and positioning, navigation, and timing (PNT). RF convergence demonstrates that many of these systems can be executed simultaneously using efficient cooperation strategies, which improves performance and limits spectral access.

Embodiments described herein provide a simultaneous positioning, navigation, timing, and communications system that cooperatively executes multiple RF services. A constant-information ranging (CIR) strategy or algorithm is defined that maintains constant information learned about an incoherent moving target by modulating a revisit interval to minimize the number of interactions. This significantly reduces spectral congestion and offers a control mechanism to dynamically manage spectral access. The CIR algorithm is validated in a simulation environment where a 91% reduction in spectral access for a particular flight path is observed while maintaining a 3-centimeter (cm) precision in ranging.

I. Introduction

To address spectral congestion in the context of ITS, embodiments described herein use a Communications and High-Precision Positioning (CHP2) system to simultaneously provide positioning, navigation, timing, and communications services to cooperative RF users. CHP2 is a two-way ranging (TWR) system that adopts many RF convergence design techniques to limit spectral access while providing higher precision (<10 cm) with limited bandwidth (10 megahertz (MHz)) and better security than alternatives such as GPS.

This result is extended by developing a CIR protocol. This algorithm dynamically reduces spectral access by modulating how often a moving target is measured. CIR quantifies the amount of information learned during each interaction and adjusts the revisit interval to maintain a constant information rate; if a target is moving in a predictable manner, the number of interactions can be reduced while maintaining the ranging precision. This reduces the spectral access of the system, which reduces the overall spectral congestion and allows other devices to operate more often. This addresses many of the issues associated with fixed resource allocation in RF networks and readily supports dynamic spectrum access techniques in the context of ITS.

II. Overview

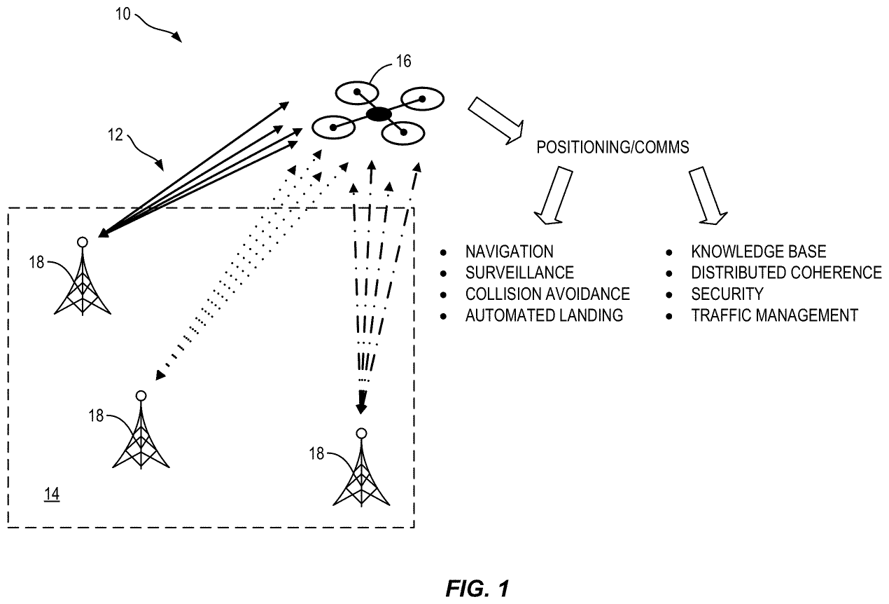

FIG. 1 is a schematic diagram of an exemplary CHP2 system 10 which provides joint positioning and communications according to embodiments disclosed herein. In the CHP2 system 10, RF signals 12 are exchanged between network nodes in order to facilitate estimation of position information of the network nodes. In the illustrated example, the network nodes include a base station 14 (e.g., a first network node) and an aircraft 16 (e.g., a second network node, such as an unmanned aerial vehicle (UAV) or another unmanned aerial system (UAS)). In an exemplary aspect, the aircraft 16 can estimate its position information (e.g., range, position, orientation, and/or acceleration) relative to the base station 14 from the exchanged RF signals 12. In some examples, the base station 14 (and each additional network node in the CHP2 system 10) can likewise estimate such position information.

The position information of the aircraft 16 can be used for various tasks, such as formation flying, coordination of safe flight paths, takeoff, landing, and taxiing. In some examples, the RF signals 12 can also carry payload data for communications between the aircraft 16 and the base station 14 or other network nodes in the CHP2 system 10. Such payload data may facilitate additional tasks, such as coordination of a formation of aircraft 16.

As illustrated in FIG. 1, the base station 14 can be a distributed base station having multiple antennas 18 to provide more accurate and/or detailed position information (e.g., in addition to range, multiple antennas can provide position and orientation estimation). Similarly, the aircraft 16 can have a multi-antenna RF transceiver. In an illustrative example, the aircraft 16 has a four-antenna transceiver and the base station 14 has three antennas 18, such that twelve RF signals 12 are exchanged between the base station 14 and the aircraft 16 to facilitate improved estimation of position information.

In an exemplary aspect, the CHP2 system 10 operates with a 10 MHz bandwidth and maintains a ranging standard deviation below 5 cm (e.g., 3 cm or less) for up to 2 kilometers (km) of range. In controlled configurations, this deviation can be driven as low as 1 millimeter (mm). This capability is facilitated by a phase accurate time-of-arrival (ToA) estimation technique, a distributed phase-coherence algorithm, iterative tracking of parameters using hidden Markov models, such as adaptive filtering techniques (e.g., Kalman filtering), and/or the CIR algorithm described further below.

It should be understood that, while FIG. 1 is described with respect to aircraft 16 in particular, exemplary embodiments may include other types of RF devices, including vehicles. For example, a radio-bearing automobile in the CHP2 system 10 may facilitate relevant positioning tasks, such as parking, street navigation, and awareness of other vehicles for passing, accelerating, stopping, and so on. A radio-bearing ship in the CHP2 system 10 can facilitate relevant positioning tasks such as navigation, formation travel, collision avoidance, docking, and so on. Embodiments of the present disclosure implemented in such vehicles may be used for assisted operation, remote control, autonomous systems, and so on. In other examples, the network nodes of the CHP2 system 10 can include an automobile, ship, train, or other vehicle, or non-vehicular applications where position information is needed or beneficial. In some examples, one or more network nodes in the CHP2 system 10 is a satellite.

It should also be understood that vehicles, base stations, or other network nodes in embodiments of the present disclosure can include more or fewer antennas than described above. In some embodiments, antennas may be distributed on a network node to optimize operation according to a particular application (e.g., for air-to-ground communication in the example depicted, or for ground-to-ground communication in the example of automobiles). For example, the antennas may be distributed to reduce ground bounce and/or multi-path interference of RF signals transmitted or received by the network node.

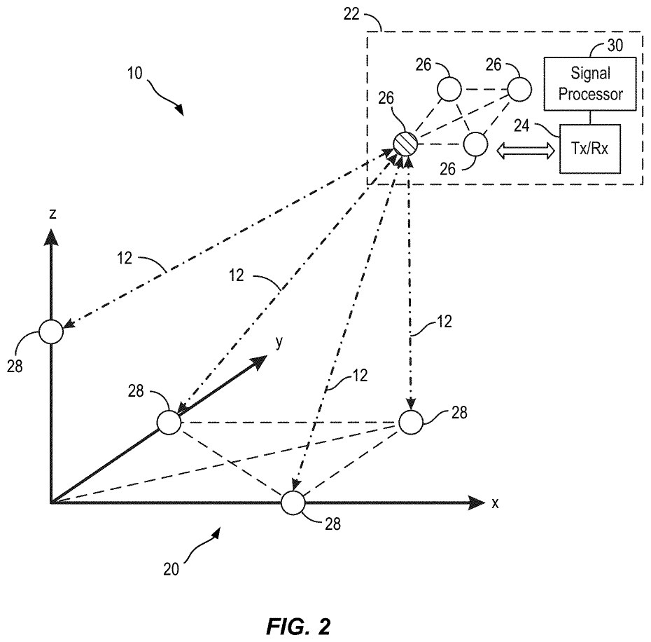

FIG. 2 is a schematic diagram of the CHP2 system 10 of FIG. 1, illustrating estimation of position information based on exchanging RF signals 12 between a first network node 20 and a second network node 22. Each network node 20, 22 can be a base station (e.g., the first network node can be the base station 14 of FIG. 1) or a vehicle (e.g., the second network node can be the aircraft 16 of FIG. 1). In addition, each network node 20, 22 in the CHP2 system 10 can also include or be implemented as an RF device. For example, the second network node 22 includes an RF transceiver 24. The RF transceiver 24 is coupled to one or more antennas 26, through which the RF transceiver 24 can communicate wirelessly with the first network node 20 (e.g., at each of one or more antennas 28).

In an exemplary aspect, the RF transceiver 24 includes an RF receiver and an RF transmitter for communicating wirelessly over RF signals 12. In some examples, the RF transceiver 24 can communicate over cellular or non-cellular RF frequency bands, over citizens broadband radio service (CBRS) frequency bands, over microwave frequency bands, over millimeter wave (mmWave) frequency bands, over terahertz frequency bands, over optical frequency bands, and so on. In some examples, the RF transceiver 24 exchanges signals having a narrow bandwidth, such as 10 MHz or less. In some examples, the RF transceiver 24 exchanges signals over a Long Term Evolution (LTE), Fifth Generation (5G), or other Third Generation Partnership Project (3GPP) cellular communication signal.

As illustrated in FIG. 2, the RF transceiver 24 can couple to an array of antennas 26. Each of the antennas 26 of the second network node 22 may exchange RF signals 12 with each of multiple antennas 28 of the first network node 20 (and additional network nodes in the CHP2 system 10). The second network node 22 further includes a signal processor 30 coupled to the RF transceiver 24 to process the RF signals 12 exchanged with the first network node 20. By processing the RF signals 12, the signal processor 30 can estimate position information of the second network node 22 based on relative distances between the antennas 26 of the second network node 22 and each of the antennas 28 of the first network node 20. In addition, a velocity, acceleration, range, bearing, altitude and/or orientation of the second network node 22 can be estimated based on the position information. The position information can be fused with additional information (e.g., additional information received via the CHP2 system 10, inertial measurement data, sensor data, GPS data) to refine the relative and/or absolute position (and/or range, velocity, acceleration, bearing, altitude, and/or orientation) of the second network node 22.

Aspects of the present disclosure describe a CHP2 system 10 which estimates the ToA of the RF signals 12 traveling between an antenna 26 of the second network node 22 and each antenna 28 of the first network node 20. A synchronization algorithm (e.g., distributed phase-coherence algorithm) measures time-of-flight (ToF) between all pairs of antennas 26, 28. These estimates are transformed into relative range, position, and/or orientation estimates.

Network nodes 20, 22 within this system 10 simultaneously perform communications and positioning tasks. These tasks are performed by transmitting and receiving a co-use joint positioning-communications waveform that contains both a communications payload and several positioning reference sequences. The positioning sequences are used to estimate the ToA of the received joint positioning-communications waveform. The payload contains timing information that drives a ToF estimation algorithm. By alternating between transmitting and receiving this information, two nodes are able to align their clocks and estimate their relative positions with high precision.

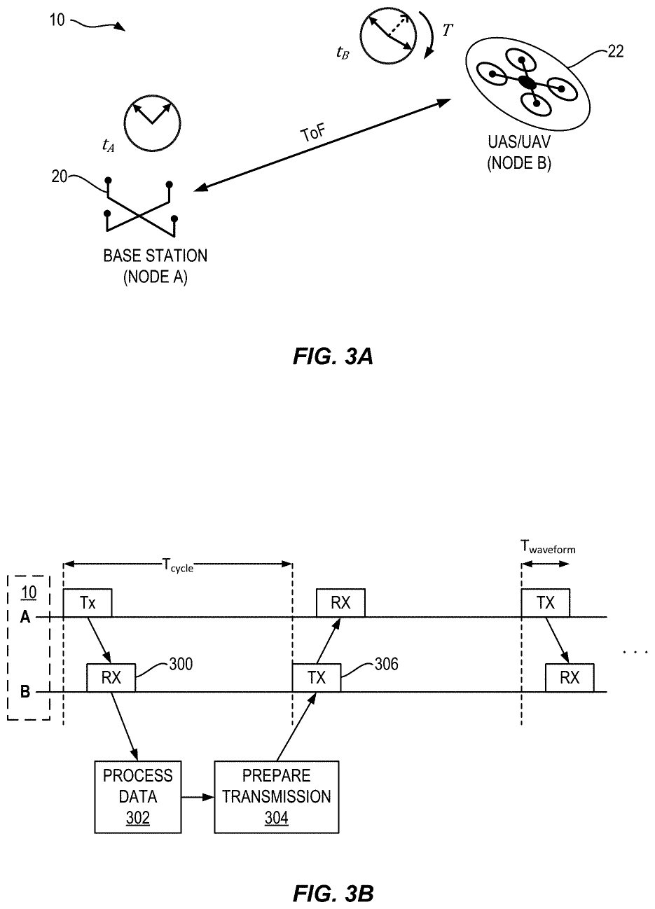

FIG. 3A is a schematic diagram of the CHP2 system, illustrating a clock offset between the first network node 20 (e.g., node A) and the second network node 22 (e.g., node B) of FIG. 2. For illustrative purposes, the first network node 20 (illustrated as node A) can be assumed to be stationary and tethered to the ground while the second network node 22 (illustrated as node B) is airborne, moving with a velocity \vec{v} and acceleration d in a three-dimensional Cartesian space.

Nodes A and B are driven by independent clocks and they communicate over a single-input-single-output (SISO) line-of-sight environment. The two nodes sequentially exchange communications waveforms that include transmit t_{(⋅),Tx} and receive t_{(⋅),Rx} timestamps. These timestamps are leveraged to estimate the stochastic processes, relative clock offsets (T) and propagation time (e.g., ToF (τ)) between the two network nodes 20, 22. Radial velocity \dot{τ} and acceleration act along the dashed line. Proposed methods readily generalize to multiple node networks operating on multi-antenna platforms.

FIG. 3B is a schematic diagram of interactions between the first network node 20 and the second network node 22 of the CHP2 system 10 of FIG. 2 over a joint positioning-communications waveform. The first network node 20 (node A) and the second network node 22 (node B) alternate between transmitting and receiving periodically over the joint positioning-communications waveform. For example, at operation 300, node B receives a first RF receive signal from node A, which includes the joint positioning-communications waveform. At operation 302, node B processes the received data to produce relative positional information. This can include estimating the ToA of all positioning sequences on all receive channels and extracting timing information from a data payload of the joint positioning-communications waveform.

In some examples, to support additional network nodes in the CHP2 system 10 without sacrificing quality of service, spatially adaptive interference mitigation techniques may also be employed at operation 302. The multi-antenna nature of devices in the CHP2 system 10 affords spatial diversity that enables a variety of spatial interference mitigation techniques, as well is multiple-input, multiple output (MIMO) communication. Adaptive techniques also allow the system to adapt to network nodes entering and exiting the network, time-varying external interference, changing network environments, and evolving channels. The adaptive techniques may address the following:

1. Internal Interference: Adding network nodes to the CHP2 system 10 also increases the number of potential interferers that each must mitigate. Due to the cooperative nature of this system, however, successive interference cancellation (SIC) techniques are a feasible approach to interference mitigation. SIC requires that a receiver reconstructs an estimate of an interfering signal, then subtract it from the signal it originally received. Network nodes within the CHP2 system 10 share information about how their waveforms are built, so this reconstruction is tractable. Mutual interference may also be limited by adaptively coordinating power levels across the CHP2 system 10 and adaptively scheduling time and frequency slots for different network nodes.

2. External Interference: The CHP2 system 10 must also contend with already congested spectral environments, in which it may not have knowledge of the interferers. In this case, the spatial diversity afforded by the multi-antenna platforms may be leveraged to implement spatial beamforming, in which an antenna array is adjusted to maximize incoming energy in the direction of other network nodes and minimizing incoming energy from the interferers. This process must also be adaptive to compensate for interferers that move within the environment.

At operation 304, node B prepares a transmission, which can include assembling the estimated position information (and in some examples, some of the information from the first received signal, such as received ToA or position estimates). At operation 306, node B transmits the joint positioning-communications waveform back to node A using a second signal (e.g., a first transmit signal). In some examples, transmissions are scheduled by a master node (e.g., one of node A or node B, or another node). In some examples, the transmissions occur every 50 milliseconds (ms) (e.g., the cycle duration T_{cycle} is 50 ms). In some examples, the joint positioning-communications waveform has a duration (T_{waveform}) of about 1 ms. This transfer of information drives the timing synchronization and ToF estimation algorithm.

III. Simultaneous Clock Synchronization and Time-of-Flight Tracking

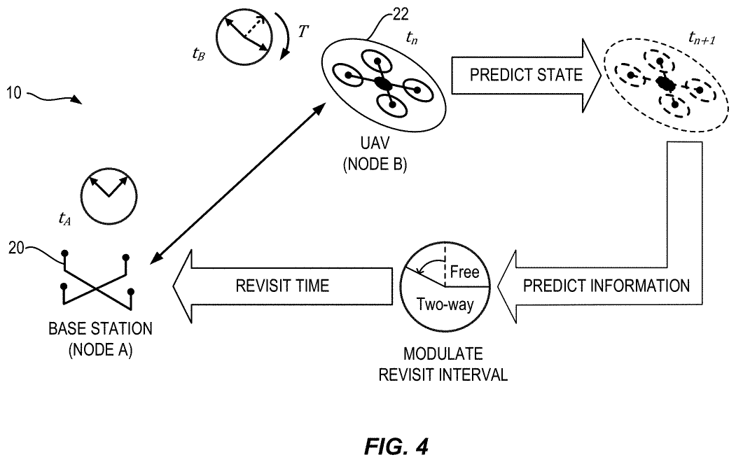

FIG. 4 is a schematic diagram of the CHP2 system 10 of FIG. 2 implementing CIR algorithm. In the illustrated CIR approach, the first network node 20 tracks the second network node 22. Based on previous measurements, the first network node 20 predicts the position of the second network node 22 during the next measurement state. Depending on how well the first network node 20 can predict the path of the second node 22, how often a measurement occurs can be modulated to maintain some target performance metric (e.g., a positioning or communication performance), such as a constant information rate. In this regard, if the path were perfectly predictable, no information would be learned by taking additional measurements, and spectral resources could be diverted to other uses.

As described above, the CHP2 system 10 simultaneously supports MIMO communications and TWR between several users in a network. This discussion focuses on two users, the first network node 20 and the second network node 22, executing SISO communications and ranging in a line-of-sight (LoS) environment. The first network node 20 (node A) is a base-station tasked with tracking the position of the second network node 22 (node B), a UAV following an arbitrary flight path.

The time-of-flight (ToF) between these users is denoted τ. The two users are driven by independent clocks which display nominal times t_{A} and t_{B}. The clock offset between the two users is denoted T such that T=t_{A}−t_{B}. These users engage in a two-way timing exchange that drives a clock synchronization and ranging algorithm. Here, components of the synchronization method that motivate the CIR algorithm are summarized.

A. Timing Exchange Protocol

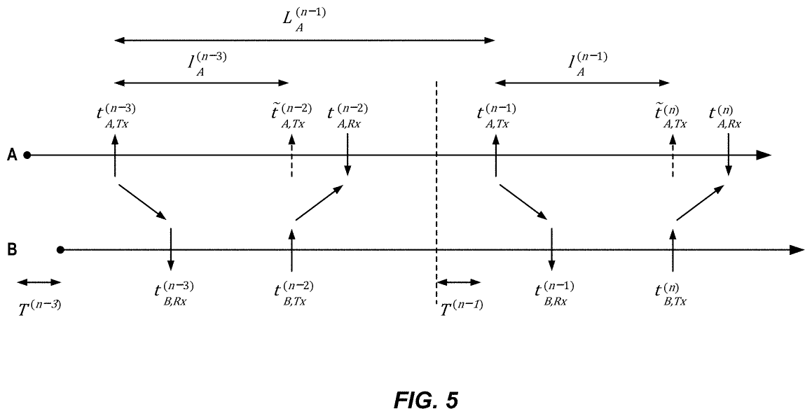

FIG. 5 is a flow diagram illustrating an exemplary timing exchange model at node A of FIG. 4 summarizing interactions between node A and node B. Node A and node B exchange timing information to drive a synchronization algorithm that estimates the range between them. Each interaction is labeled a frame and each pair of frames is labelled a cycle. During frame (n−1), node A transmits at time t_{A,Tx}⁽ⁿ⁻¹⁾ to node B, which receives the transmission at time

t_{B,Tx}⁽ⁿ⁻¹⁾=t_{A,Tx}⁽ⁿ⁻¹⁾+τ⁽ⁿ⁻¹⁾−T⁽ⁿ⁻¹⁾ Equation 1

Node B waits for some fixed time 1 and transmits during the next frame (n) at time t_{B,Tx}⁽ⁿ⁾, which node A receives at time

t_{B,Tx}⁽ⁿ⁾=t_{A,Tx}⁽ⁿ⁾+τ⁽ⁿ⁾−T⁽ⁿ⁾ Equation 2

The frame length as observed by node A is

l_{A}⁽ⁿ⁻¹⁾=\tilde{t}_{A,Tx}⁽ⁿ⁾−T_{A,Tx}⁽ⁿ⁻¹⁾ Equation 3

and the cycle length as observed by node A is

L_{A}⁽ⁿ⁻¹⁾=t_{A,Tx}⁽ⁿ⁻¹⁾−t_{A,Tx}⁽ⁿ⁻³⁾ Equation 4

Having access to the transmit and receive timestamps, one could opt to realize distributed coherence and ranging using optimal estimators. However, embodiments described herein leverage Extended Kalman Filtering (EKF) ideology to do the same.

B. Tracking Preliminaries

It is assumed that the clock offset T and time-of-flight τ follow a first-order Markov model.

1. State Transition

During cycle {(n−1), (n)}, the state variables during frame (n−1) may be expressed as a function of frame (n−3) such that

\hat{x}₍₋₎⁽ⁿ⁻¹⁾=F(L_{A}⁽ⁿ⁻¹⁾)\hat{x}⁽ⁿ⁻³⁾+w⁽ⁿ⁻¹⁾ Equation 5

where w^{(⋅)}˜ [symbol] (0, Q^{(⋅)}) is the process noise, assumed to be drawn from a zero-mean, multivariate normal distribution. The state space variables x and transition matrix F at any arbitrary frame are

$$x = [ \begin{matrix}τ \\ \dot{τ} \\ T \\ \dot{T}\end{matrix} ] , F ( {L}_{A} ) = [ \begin{matrix}1 & {L}_{A} & 0 & 0 \\ 0 & 1 & 0 & 0 \\ 0 & 0 & 1 & {L}_{A} \\ 0 & 0 & 0 & 1\end{matrix} ] \qquad Equation 6$$

The predicted state covariance matrix is

\hat{P}₍₋₎⁽ⁿ⁻¹⁾=F⁽ⁿ⁻¹⁾\hat{P}⁽ⁿ⁻³⁾F⁽ⁿ⁻¹⁾^{^{T+Q}}⁽ⁿ⁻¹⁾ Equation 7

where \hat{P}⁽ⁿ⁻³⁾ is the error covariance matrix from the previous cycle and F⁽ⁿ⁻¹⁾ is a shorthand notation for F(L_{A}⁽ⁿ⁻¹⁾). This notation is summarized in Table I.

TABLE I
Extended Kalman Filter Notation

| | |
|---|---|
| \hat{x}₍₋₎, \hat{x} | Predicted and estimated state parameters |
| \|x\| | Cardinality of state space |
| F | State transition matrix |
| \hat{P}₍₋₎, \hat{P} | Predicted and estimated state covariance matrix |
| Q, R | State and measurement noise covariance matrix |
| w, v | State and measurement noise |
| \hat{z}₍₋₎, \hat{z} | Predicted and observed measurements |
| h, H | Measurement transition and Jacobian matrix |
| S | Measurement covariance matrix |
| K | Kalman gain |

2. Measurement Transition

The transmit timestamps constitute the controls and receive timestamps serve as measurements in this Kalman filter set-up. The measurement transition model is

\hat{z}₍₋₎⁽ⁿ⁻¹⁾=u⁽ⁿ⁻¹⁾+h(\hat{x}₍₋₎⁽ⁿ⁻¹⁾)+v⁽ⁿ⁻¹⁾ Equation 8

with measurements z and controls u defined as

$${z}^{( n - 1 )} = [ \begin{matrix}{t}_{B , Rx}^{( n - 1 )} \\ {t}_{A , Rx}^{( n )}\end{matrix} ] , {u}^{( n - 1 )} = [ \begin{matrix}{t}_{A , Tx}^{( n - 1 )} \\ {t}_{B , Tx}^{( n )}\end{matrix} ] \qquad Equation 9$$

and transition function h defined as

$$h ( {\hat{x}}_{( - )}^{( n - 1 )} ) = [ \begin{matrix}{τ}^{( n - 1 )} - {\dot{T}}^{( n - 1 )} \\ {τ}^{( n - 1 )} + {\dot{τ}}^{( n - 1 )} {l}_{A}^{( n - 1 )} + {T}^{( n - 1 )} + {\dot{T}}^{( n - 1 )} {l}_{A}^{( n - 1 )}\end{matrix} ] \qquad Equation 10$$

The frame length is computed as

$${l}_{A}^{( n - 1 )} = \frac{{t}_{B , Tx}^{( n )} - {t}_{A , Tx}^{( n - 1 )} + {T}^{( n - 1 )}}{1 - {\dot{T}}^{( n - 1 )}} \qquad Equation 11$$

The measurement noise v^{(⋅)}˜ [symbol] (0, R^{(⋅)}) is assumed to be drawn from a zero-mean, multivariate normal distribution. And

$${H}^{( n - 1 )} = \frac{\partial h ( \hat{x} )}{\partial \hat{x}} {\vert}_{{\hat{x}}_{( - )}^{( n - 1 )}} \qquad Equation 12$$

is the measurement Jacobian.

IV. Dynamic Spectrum Access

In some embodiments, the CHP2 system operates using fixed transmission intervals. In many scenarios, however, a user may move very predictably, so each measurement does not yield very much new information. In this scenario, taking measurements at fixed intervals is redundant and wastes spectral resources.

Spectral congestion can be reduced by modulating the revisit interval to only take a measurement when it will yield significant information about the target. By focusing on maintaining a constant information learned about the target, further embodiments can reduce the number of transmissions, thereby opening the spectrum for other uses. Multiple hypothesis testing is leveraged to predict and sustain a constant information rate accumulated by each measurement.

A. Cycle Length Modulation

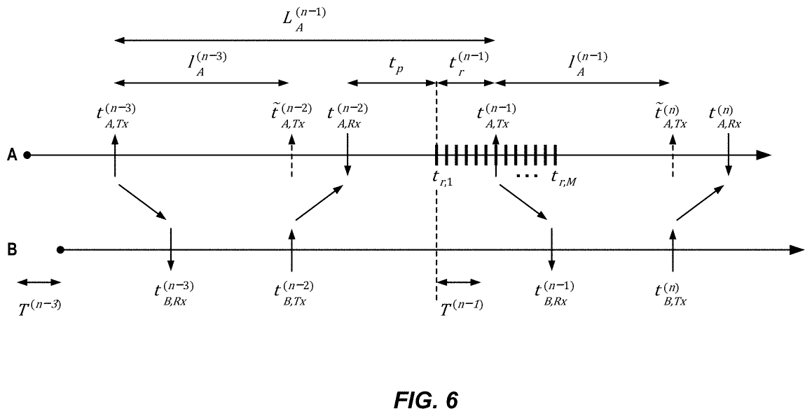

FIG. 6 is a flow diagram illustrating an updated timing exchange model as in FIG. 5 for dynamically reducing spectral access when a target behaves predictably. For a given scenario, a constant information rate I_{const} is defined that the CHP2 system intends to maintain. After each cycle, some processing time tₚ is allowed and a set of potential revisit times tᵣ^{m}, ∀m∈{1, 2, . . . , M} are considered. The potential cycle lengths become

L_{A}^{m,(n-1)}=(t_{A,Rx}⁽ⁿ⁻²⁾−t_{A,Tx}⁽ⁿ⁻³⁾)+tₚ+tᵣ^{m} Equation 13

For each potential revisit time, the quantity of information attained is predicted by conducting a measurement and choosing the cycle length that most closely matches the constant information constraint, i.e.

$${L}_{A}^{( n - 1 )} = {arg min}_{{L}_{A}^{m , ( n - 1 )}} \vert {I}^{m , ( n - 1 )} - {I}_{const} \vert \qquad Equation 14$$

where |⋅| is the absolute operator and I^{m,(n-1)} is the predicted information gained from a measurement at time tᵣ^{m}, calculated using Equation 18. Given this choice, node A instigates the next transmission at time

t_{A,Rx}⁽ⁿ⁻¹⁾=t_{A,Rx}⁽ⁿ⁻³⁾+L_{A}⁽ⁿ⁻¹⁾ Equation 15

and executes the Kalman Filter tracking methodology defined in Algorithm 1.

B. Estimation Rate

Estimation rate quantifies the rate of information gained by subsequent measurements of a target. Under a Gaussian assumption, the estimation rate is given by

$${R}_{est} \leq \frac{1}{2 t} {log}_{2} ( \frac{{σ}_{proc}^{2} + {σ}_{est}^{2}}{{σ}_{est}^{2}} ) \qquad Equation 16$$

where σ_{proc}² and σₑₛₜ² are the process and estimation noise variances and t is the measurement interval.

In the context of CHP2, the predicted estimation rate is

$${R}_{est}^{m , ( n - 1 )} \leq \frac{1}{2 {L}_{A}^{m , ( n - 1 )}} {log}_{2} ( \frac{\vert {S}^{( n - 1 )} \vert}{\vert {R}^{( n - 1 )} \vert} ) \qquad Equation 17$$

where L_{A}^{m,(n-1)} is the m^{th} hypothetical cycle length and |⋅| is a determinant operator. S⁽ⁿ⁻¹⁾=H⁽ⁿ⁻¹⁾Q⁽ⁿ⁻¹⁾H⁽ⁿ⁻¹⁾H⁽ⁿ⁻¹⁾^{^{T}}+R⁽ⁿ⁻¹⁾ is a combination of the estimation noise covariance matrix R and the process noise covariance matrix Q projected onto the measurement space via the Jacobian H. The estimation rate may be interpreted as the minimum number of bits needed to encode the Kalman residual. The predicted information is then written as a function of m such that

$${I}^{m , ( n - 1 )} = \frac{1}{2} {log}_{2} ( \frac{\vert {S}^{( n - 1 )} \vert}{\vert {R}^{( n - 1 )} \vert} ) \qquad Equation 18$$

This quantity is a function of the cycle length, so modulating the revisit time will directly change the amount of information gained by a given measurement.

V. Simulation Results

This section demonstrates that the CIR protocol described above significantly reduces spectral access compared to a fixed interval protocol in the context of CHP2.

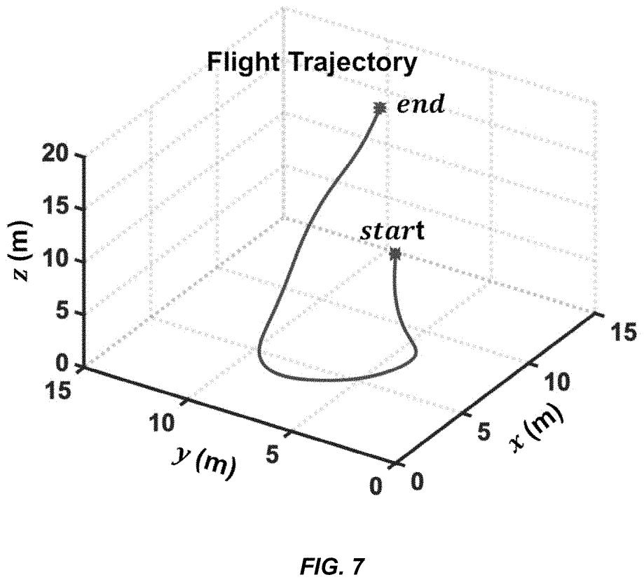

FIG. 7 is a graphical representation of a simulated flight trajectory of node B for 60 seconds with node A located at the origin. A stationary, ground user is simulated as node A and a mobile, airborne user following an arbitrary flight path is simulated as node B.

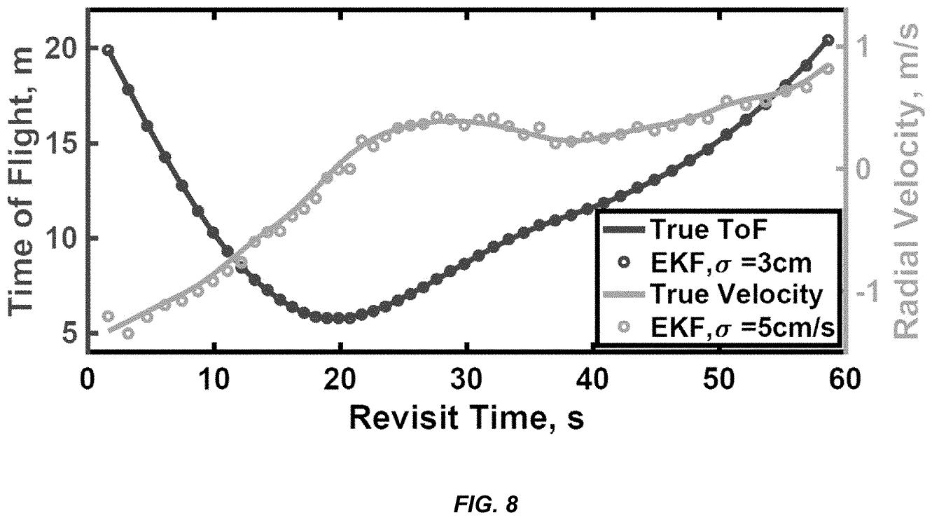

FIG. 8 is a graphical representation of true and estimated relative ToF and radial velocity between node A and node B. The EKF estimates, indicated here at every measurement instance, are precise up to 3 cm and 5 cm/s, respectively. When the target's flight path diverges from predictions (during the curve vs. straight line) the frequency of measurements increases.

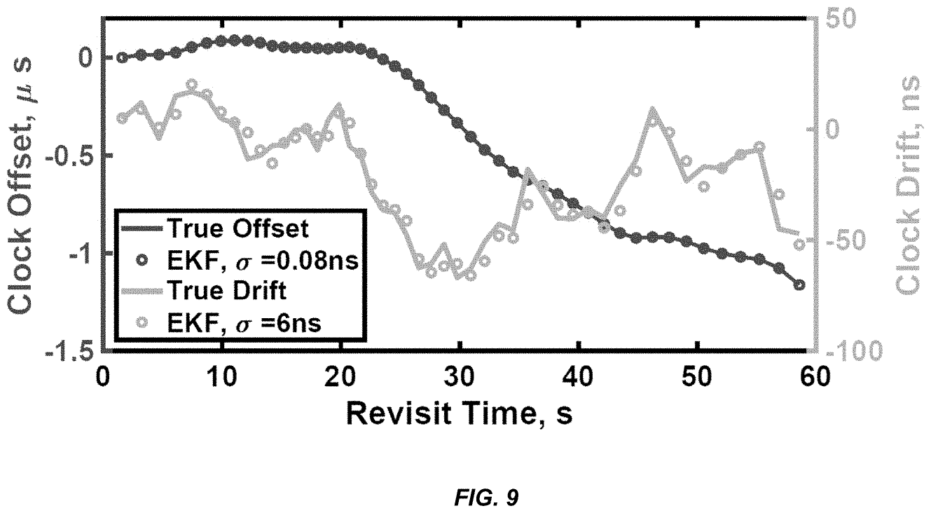

FIG. 9 is a graphical representation of true and estimated relative clock offset and drift between node A and node B. The clock offset and drift are modeled using realistic oscillator characteristics, and the EKF estimates are precise up to 0.08 nanoseconds (ns) and 6 ns, respectively. When the relative clock behavior diverges from the model (during the curve vs. straight line) measurements occur more often.

It is assumed that the state and measurement noise covariance matrices are known a priori. These may be adaptively estimated in real time. These matrices are modeled as a function of integrated signal to noise ratio (SNR) to fit the flight trajectory. CHP2 operates with 30 decibels (dB) of waveform integration gain and maintains an operational instantaneous SNR of 15 dB, which yields ToA estimates precise to within 0.1 ns (3 cm).

A constant information rate is defined as I_{const}=15 bits, processing time is defined as tₚ=30 ms, and a lattice of revisit time hypotheses tᵣ^{m} between 0 and 2 seconds (s) is constructed with a resolution of 5 ms. This scenario is simulated for 60 seconds, during which a traditional CHP2 user would ordinarily transmit a joint positioning-communications waveform every 100 ms for a total of 600 measurements.

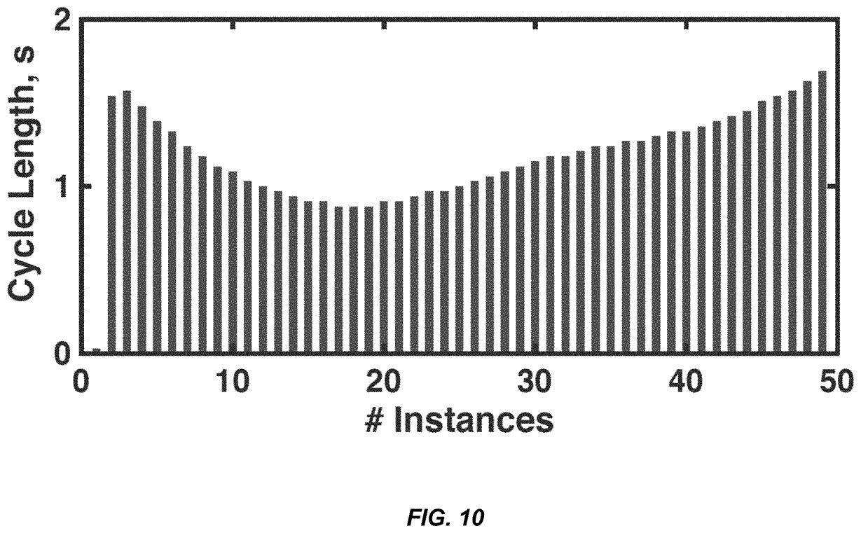

FIG. 10 is a graphical representation of optimal cycle length to maintain a constant information of 15 bits at each measurement instance. The CIR protocol is implemented as defined by Algorithm 1 given the above parameters. To maintain the 15-bit information constraint, the revisit interval is increased from 100 ms to over 1 s, resulting in only 50 measurements in the same 60 s time frame. This reduces the spectral usage by over 91% for the flight path depicted in FIG. 7. Despite the drastic reduction in spectral resources, CHP2 maintains a 3 cm precision in ranging and synchronizing clocks up to 0.08 ns (see FIGS. 8 and 9). These figures also demonstrates that as the target exhibits less predictable behavior (during the curve vs. straight line), node A measures node B more often because the behavior is more divergent from the prediction so there is more information to be gained by taking a measurement.

Algorithm 1: Constant Information Ranging Protocol

```
while true do
  L_{A}^{m,(n-1)} ∈ {L_{A}^{1,(n-1)}, L_{A}^{2,(n-1)}, . . . , L_{A}^{M,(n-1)}}
  for m = 1: M do
    \hat{x}₍₋₎⁽ⁿ⁻¹⁾ = F(L_{A}⁽ⁿ⁻¹⁾)\hat{x}⁽ⁿ⁻³⁾
    \hat{P}₍₋₎⁽ⁿ⁻¹⁾ = F⁽ⁿ⁻¹⁾\hat{P}⁽ⁿ⁻³⁾F⁽ⁿ⁻¹⁾^{^{T}} + Q⁽ⁿ⁻¹⁾
    ${H}^{( n - 1 )} = \frac{\partial h ( \hat{x} )}{\partial \hat{x}} {\vert}_{{\hat{x}}_{( - )}^{( n - 1 )}}$
    S⁽ⁿ⁻¹⁾ = H⁽ⁿ⁻¹⁾\hat{P}⁽ⁿ⁻¹⁾H⁽ⁿ⁻¹⁾^{^{T}} + R⁽ⁿ⁻¹⁾
    ${I}^{m , ( n - 1 )} = \frac{1}{2} {log}_{2} ( \frac{\vert {s}^{( n - 1 )} \vert}{\vert {R}^{( n - 1 )} \vert} )$
  end
  ${L}_{A}^{( n - 1 )} = {argmin}_{{L}_{A}^{m , ( n - 1 )}} \vert {I}^{m , ( n - 1 )} - {I}_{const} \vert$
  t_{A,Tx}⁽ⁿ⁻¹⁾ = t_{A,Tx}⁽ⁿ⁻³⁾ + L_{A}⁽ⁿ⁻¹⁾, conduct two-way timing exchange
  \hat{z}₍₋₎⁽ⁿ⁻¹⁾ = u⁽ⁿ⁻¹⁾ + h(\hat{x}₍₋₎⁽ⁿ⁻¹⁾)
  K⁽ⁿ⁻¹⁾ = \hat{P}₍₋₎⁽ⁿ⁻¹⁾H⁽ⁿ⁻¹⁾^{^{T}}S⁽ⁿ⁻¹⁾^{^{−1}}
  \hat{x}⁽ⁿ⁻¹⁾ = \hat{x}₍₋₎⁽ⁿ⁻¹⁾ + K⁽ⁿ⁻¹⁾(z⁽ⁿ⁻³⁾ − \hat{z}₍₋₎⁽ⁿ⁻¹⁾)
  \hat{P}⁽ⁿ⁻¹⁾ = (I_{|x|} − K⁽ⁿ⁻¹⁾H⁽ⁿ⁻¹⁾)\hat{P}₍₋₎⁽ⁿ⁻¹⁾
end
```

VI. Method for Tracking Position Information

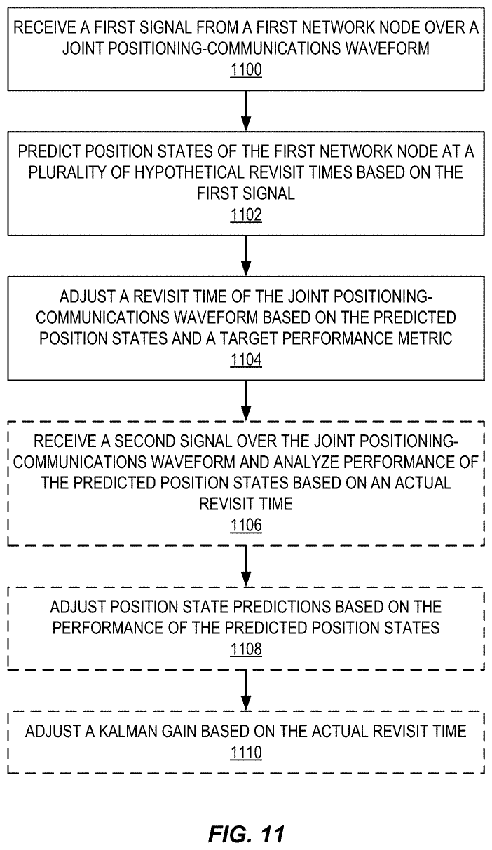

FIG. 11 is a flow diagram illustrating a process for information ranging in a joint positioning-communications system. Dashed boxes represent optional steps. The process begins at operation 1100, with receiving a first signal from a first network node over a joint positioning-communications waveform. The process continues at operation 1102, with predicting position states of the first network node at a plurality of hypothetical revisit times based on the first signal. The process continues at operation 1104, with adjusting a revisit time of the joint positioning-communications waveform based on the predicted position states and a target performance metric. In an exemplary aspect, the target performance metric is a positioning performance metric (e.g., accuracy of the predicted position state), a communication performance metric (e.g., a data rate, a packet loss rate), or a combination thereof. In certain embodiments, the performance metric is a constant information/data rate.

The process may optionally continue at operation 1106, with receiving a second signal over the joint positioning-communications waveform and analyzing performance of the predicted position states based on an actual revisit time. The process may optionally continue at operation 1108, with adjusting position state predictions based on the performance of the predicted position states. The process may optionally continue at operation 1110, with adjusting a Kalman gain (e.g., a Kalman gain matrix) based on the actual revisit time (e.g., based on a comparison with the prediction).

Although the operations of FIG. 11 are illustrated in a series, this is for illustrative purposes and the operations are not necessarily order dependent. Some operations may be performed in a different order than that presented. Further, processes within the scope of this disclosure may include fewer or more steps than those illustrated in FIG. 11.

VII. Computer System

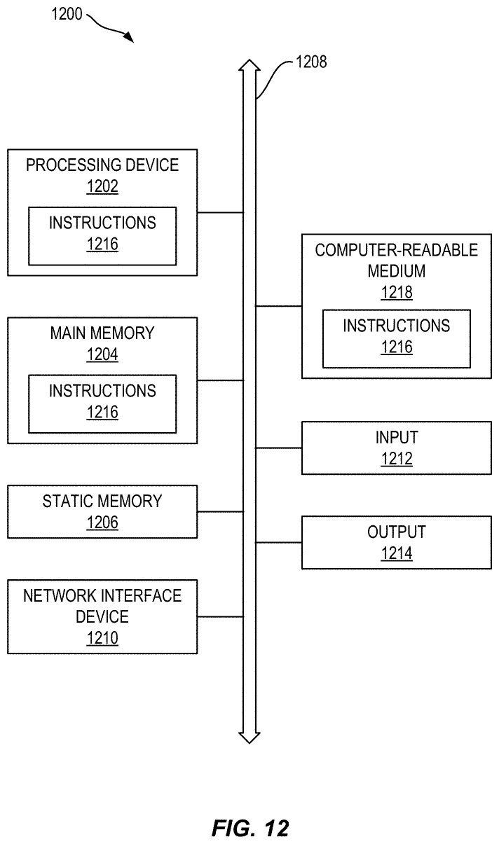

FIG. 12 is a schematic diagram of a generalized representation of an exemplary computer system 1200 that could be used to perform any of the methods or functions described above, such as constant information ranging in a joint positioning-communications system. In some examples, one or more of the network nodes 20, 22 of FIG. 2 are implemented as the computer system 1200. In this regard, the computer system 1200 may be a circuit or circuits included in an electronic board card, such as, a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computer system 1200 in this embodiment includes a processing device 1202 or processor (e.g., the signal processor 30 of FIG. 2), a main memory 1204 (e.g., read-only memory (ROM), flash memory, dynamic random access memory (DRAM), such as synchronous DRAM (SDRAM), etc.), and a static memory 1206 (e.g., flash memory, static random access memory (SRAM), etc.), which may communicate with each other via a data bus 1208. Alternatively, the processing device 1202 may be connected to the main memory 1204 and/or static memory 1206 directly or via some other connectivity means. In an exemplary aspect, the processing device 1202 could be used to perform any of the methods or functions described above.

The processing device 1202 represents one or more general-purpose processing devices, such as a microprocessor, central processing unit (CPU), or the like. More particularly, the processing device 1202 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 1202 is configured to execute processing logic in instructions for performing the operations and steps discussed herein.

The various illustrative logical blocks, modules, and circuits described in connection with the embodiments disclosed herein may be implemented or performed with the processing device 1202, which may be a microprocessor, field programmable gate array (FPGA), a digital signal processor (DSP), an application-specific integrated circuit (ASIC), or other programmable logic device, a discrete gate or transistor logic, discrete hardware components, or any combination thereof designed to perform the functions described herein. Furthermore, the processing device 1202 may be a microprocessor, or may be any conventional processor, controller, microcontroller, or state machine. The processing device 1202 may also be implemented as a combination of computing devices (e.g., a combination of a DSP and a microprocessor, a plurality of microprocessors, one or more microprocessors in conjunction with a DSP core, or any other such configuration).

The computer system 1200 may further include a network interface device 1210. The computer system 1200 also may or may not include an input 1212, configured to receive input and selections to be communicated to the computer system 1200 when executing instructions. The input 1212 may include, but not be limited to, a touch sensor (e.g., a touch display), an alphanumeric input device (e.g., a keyboard), and/or a cursor control device (e.g., a mouse). In an exemplary aspect, the RF transceiver 24 of FIG. 2 is an input 1212 to the computer system 1200. The computer system 1200 also may or may not include an output 1214, including but not limited to a display, a video display unit (e.g., a liquid crystal display (LCD) or a cathode ray tube (CRT)), or a printer. In some examples, some or all inputs 1212 and outputs 1214 may be combination input/output devices. In an exemplary aspect, the RF transceiver 24 of FIG. 2 is also an output 1214 of the computer system 1200.

The computer system 1200 may or may not include a data storage device that includes instructions 1216 stored in a computer-readable medium 1218. The instructions 1216 may also reside, completely or at least partially, within the main memory 1204 and/or within the processing device 1202 during execution thereof by the computer system 1200, the main memory 1204, and the processing device 1202 also constituting computer-readable medium. The instructions 1216 may further be transmitted or received via the network interface device 1210.

While the computer-readable medium 1218 is shown in an exemplary embodiment to be a single medium, the term “computer-readable medium” should be taken to include a single medium or multiple media (e.g., a centralized or distributed database, and/or associated caches and servers) that store the one or more sets of instructions 1216. The term “computer-readable medium” shall also be taken to include any medium that is capable of storing, encoding, or carrying a set of instructions for execution by the processing device 1202 and that causes the processing device 1202 to perform any one or more of the methodologies of the embodiments disclosed herein. The term “computer-readable medium” shall accordingly be taken to include, but not be limited to, solid-state memories, optical medium, and magnetic medium.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

Those skilled in the art will recognize improvements and modifications to the preferred embodiments of the present disclosure. All such improvements and modifications are considered within the scope of the concepts disclosed herein and the claims that follow.

What is claimed is:

1. A method for information ranging in a joint positioning-communications system, the method comprising:
receiving a first signal from a first network node over a joint positioning-communications waveform;
predicting position states of the first network node at a plurality of hypothetical revisit times based on the first signal; and
adjusting a revisit time of the joint positioning-communications waveform based on the predicted position states and a target performance metric.

2. The method of claim 1, wherein the target performance metric comprises one or more of a positioning performance metric or a communication performance metric.

3. The method of claim 2, wherein the target performance metric comprises a constant data rate.

4. The method of claim 1, further comprising receiving a second signal over the joint positioning-communications waveform and analyzing performance of the predicted position states based on an actual revisit time.

5. The method of claim 4, further comprising adjusting position state predictions based on the performance of the predicted position states.

6. The method of claim 4, further comprising adjusting a Kalman gain based on the actual revisit time.

7. The method of claim 1, further comprising:
estimating a first clock offset from the first network node using the first signal;
estimating a first time delay of the first signal using the first signal; and
estimating an initial position state from the estimated first clock offset and the estimated first time delay.

8. The method of claim 7, wherein the predicted position states of the first network node are based on the estimated initial position state and data in the first signal.

9. The method of claim 7, further comprising iteratively tracking one or more parameters selected from the estimated first clock offset, the estimated first time delay, or the estimated initial position state.

10. The method of claim 9, wherein iteratively tracking the one or more parameters comprises applying linear or non-linear adaptive filtering to each of the one or more parameters.

11. The method of claim 10, wherein applying the linear or non-linear adaptive filtering comprises applying a Kalman filter or a particle filter to each of the one or more parameters.

12. The method of claim 9, wherein iteratively tracking the one or more parameters comprises applying adaptive estimation to each of the one or more parameters.

13. A radio frequency (RF) device, comprising:
an RF transceiver; and
a signal processor coupled to the RF transceiver and configured to:
receive a first signal from a first network node over a joint positioning-communications waveform;
predict position information for the first network node at a plurality of revisit times based on the first signal; and
adjust timing of the joint positioning-communications waveform based on the predicted position information and a target performance metric.

14. The RF device of claim 13, wherein the RF device comprises a vehicle.

15. The RF device of claim 14, wherein:
the vehicle is an unmanned aerial vehicle; and
the first network node is a base station or another unmanned aerial vehicle.

16. The RF device of claim 13, wherein the RF device comprises a base station.

17. The RF device of claim 16, wherein the first network node is an unmanned aerial vehicle.

18. The RF device of claim 13, wherein the target performance metric comprises one or more of a positioning performance metric or a communication performance metric.

19. The RF device of claim 13, wherein the signal processor is further configured to:
estimate a first clock offset from the first network node using the first signal;
estimate a first time delay of the first signal using the first signal; and
estimate an initial position state from the estimated first clock offset and the estimated first time delay.

20. The RF device of claim 19, wherein the signal processor is further configured to iteratively track one or more parameters selected from the estimated first clock offset, the estimated first time delay, or the estimated initial position state
